(19) United States
(12) Patent Application Publication
(10) Pub. No.: US 2021/0223913 A1
(43) Pub. Date: Jul. 22, 2021

(54) TOUCH PANEL, TOUCH DISPLAY DEVICE AND MANUFACTURING METHOD OF TOUCH PANEL

(71) Applicants: HEFEI XINSHENG OPTOELECTRONICS TECHNOLOGY CO., LTD., Hefei (CN); BOE TECHNOLOGY GROUP CO., LTD., Beijing (CN)

(72) Inventor: Guiyu Zhang, Beijing (CN)

(21) Appl. No.: 16/652,182

(22) PCT Filed: Sep. 23, 2019
(86) PCT No.: PCT/CN2019/107314

§ 371 Date: Mar. 30, 2020

(30) Foreign Application Priority Data
Sep. 26, 2018 (CN) 201811144153.8

(51) Int. Cl. G06F 3/044

(52) U.S. Cl. CPC G06F 3/0445; G06F 3/0446; G06F 2203/04102; G06F 2203/04107; G06F 2203/04103

(57) ABSTRACT

A touch panel, a touch display device, and a manufacturing method of a touch panel are provided. The touch panel includes a base substrate; a touch layer on the base substrate; and a transparent flexible insulating layer between the touch layer and the base substrate.

### CROSS-REFERENCE TO RELATED APPLICATION(S)

This application is a Section 371 National Stage Application of International Application No. PCT/CN2019/107314, filed on Sep. 23, 2019, entitled “TOUCH PANEL, TOUCH DISPLAY DEVICE AND MANUFACTURING METHOD OF TOUCH PANEL”, which claims the benefit of Chinese Patent Application No. 201811144153.8 filed on Sep. 26, 2018 in the National Intelligent Property Administration of China, the whole disclosure of which is incorporated herein by reference.

### TECHNICAL FIELD

The present disclosure relates to the field of display technology, and in particular, to a touch panel, a touch display device, and a manufacturing method of a touch panel.

### BACKGROUND

With the rapid development of human-computer interaction products, the demand for touch panels has grown rapidly. There are various touch technologies used in the touch panels. Some mainstream technologies include One Glass Solution (OGS), GG, GF, GFF, On-Cell, In-Cell and other technologies. In the OGS touch technology, a solution of a single glass substrate is provided. The OGS touch technology has an advantage of thinness and lightness, so that it is favored by customers and it is applied in more and more products. In a touch panel using the OGS touch technology (which may be referred to as OGS touch panel), a sensor touch layer is directly formed on a glass carrier (i.e., base substrate), so that the touch panel may have a relatively small thickness.

### SUMMARY

Embodiments of the present disclose provide a touch panel, including a base substrate; a touch layer on the base substrate; and a transparent flexible insulating layer between the touch layer and the base substrate.

In some embodiments, the flexible insulating layer is in contact with a surface of the base substrate facing the touch layer.

In some embodiments, an orthographic projection of the flexible insulating layer on the base substrate completely covers an orthographic projection of the touch layer on the base substrate.

In some embodiments, the touch layer includes: a first touch pattern layer; and a second touch pattern layer, the first touch pattern layer being closer to the flexible insulating layer than the second touch pattern layer; and wherein the touch panel further includes: a first insulating layer between the first touch pattern layer and the second touch pattern layer; and a second insulating layer located on a side of the second touch pattern layer facing away from the flexible insulating layer.

In some embodiments, the flexible insulating layer is made of polyimide.

In some embodiments, the flexible insulating layer has a thickness in a range of 1 μm to 10 μm.

In some embodiments, the base substrate serves as a protective cover of the touch panel.

In some embodiments, the base substrate is a glass substrate.

In some embodiments, the touch panel includes a display area and a non-display area on a periphery of the display area, and the touch panel further includes a peripheral shielding layer located in the non-display area and between the flexible insulating layer and the touch layer.

In some embodiments, an orthographic projection of the flexible insulating layer on the base substrate coincides with the display area.

In some embodiments, an orthographic projection of the flexible insulating layer on the base substrate covers the display area, and at least partially overlaps with the non-display area.

In some embodiments, the touch layer includes a first touch pattern layer; and the touch panel further includes: an additional substrate on a side of the touch panel facing away from the base substrate; a second touch pattern layer, which is located on a side of the additional substrate facing the base substrate and is closer to the additional substrate than the first touch pattern layer; and an adhesive layer between the first touch pattern layer and the second touch pattern layer.

In some embodiments, the touch layer includes a first touch pattern layer; and the touch panel further includes: a supporting film on a side of the touch panel facing away from the base substrate; a second touch pattern layer, which is located on a side of the supporting film facing the base substrate and is closer to the supporting film than the first touch pattern layer; and an adhesive layer between the first touch pattern layer and the second touch pattern layer.

In some embodiments, an orthographic projection of each of the first touch pattern layer and the second touch pattern layer on the base substrate falls into an orthographic projection of the flexible insulating layer on the base substrate.

In some embodiments, the touch panel is an OGS touch panel.

Embodiments of the present disclose further provide a touch display device, including the touch panel as any one of the above embodiments.

Embodiments of the present disclose further provide a manufacturing method of a touch panel, including: forming a transparent flexible insulating layer on a base substrate; and forming a touch layer on the flexible insulating layer.

In some embodiments, the step of forming a transparent flexible insulating layer on a base substrate includes: coating the base substrate with a flexible insulating material; and baking the flexible insulating material coated on the base substrate to form the flexible insulating layer.

In some embodiments, before forming the touch layer, the method further includes: forming a peripheral shielding layer surrounding a display area of the touch panel on the flexible insulating layer.

### BRIEF DESCRIPTION OF THE DRAWINGS

In order to illustrate technical solutions of embodiments of the present disclosure more clearly, accompanying drawings of the embodiments will be briefly described below. It should be understood that the drawings described below only relate to some embodiments of the present disclosure, but do not limit the present disclosure.

FIG. 1 is a schematic plan view of a touch panel according to some embodiments of the present disclosure;

FIG. 2A schematically illustrates a cross-sectional view, which is taken along line A-A, of the touch panel shown in FIG. 1;

FIG. 2B schematically illustrates a cross-sectional view, which is taken along line A-A, of the touch panel shown in FIG. 1;

FIG. 3 schematically illustrates a cross-sectional view of a touch panel according to some embodiments of the present disclosure;

FIG. 4 schematically illustrates an exemplary structure of a touch layer in a touch panel according to some embodiments of the present disclosure;

FIG. 5 schematically illustrates a cross-sectional view of a touch panel according to some embodiments of the present disclosure;

FIG. 6 is a schematic structural view of a touch display device according to some embodiments of the present disclosure;

FIG. 7 shows a flowchart of a manufacturing method of a touch panel according to some embodiments of the present disclosure;

FIG. 8 shows a specific flowchart of step S10 in FIG. 7;

FIG. 9 shows a specific flowchart of step S30 in FIG. 7;

FIG. 10a to FIG. 10g sequentially illustrate processes of forming various film layer structures in a manufacturing process of a touch panel according to some embodiments of the disclosure;

FIG. 11 is a schematic structural view of a touch display device according to some other embodiments of the present disclosure; and

FIG. 12 is a schematic structural view of a touch display device according to some other embodiments of the present disclosure.

### DETAILED DESCRIPTION OF EMBODIMENTS

In order to illustrate objectives, technical solutions and advantages of the present disclosure more clearly, embodiments of the present disclosure will be described in detail below with reference to accompanying drawings. It should be understood that the following description of the embodiments is intended to illustrate and explain the general concept of the present disclosure, and should not be construed as limiting the present disclosure. In the specification and the drawings, the same or similar reference numerals refer to the same or similar parts or components. For sake of clarity, the drawings are not necessarily drawn to scale, and some well-known components and structures may be omitted from the drawings.

Unless otherwise defined, technical or scientific terms used in the present disclosure shall have ordinary meanings understood by those skilled in the art to which the present disclosure belongs. Terms such as “first”, “second”, and the like used in the present disclosure do not indicate any order, quantity, or importance, but are only used to distinguish different components. The word “a” or “an” does not exclude plural forms. Words such as “comprising”, “comprise”, “including” or “include” mean that an element or item preceding the words contains elements or items following the words and equivalents thereof without excluding other elements or items. Words such as “connected” or “connecting” are not limited to physical or mechanical connections, but may include an electrical connection which may be direct or indirect. Terms such as “up”, “down”, “left”, “right”, “top”, “bottom” or the like are only used to indicate a relatively positional relationship, and the relatively positional relationship may be correspondingly changed when an absolute position of the described object is changed. When an element such as layer, film, region, or substrate is referred to as being “on” or “under” another element, the element may be “directly on” or “directly under” the another element, or there may be an intermediate element between the two elements.

In this context, unless otherwise stated, an expression “touch layer” or “touch pattern layer” refers to a layer where the touch electrodes are located. For example, in order to implement a touch function, the touch panel may include a plurality of touch electrodes, and the patterned touch electrodes are disposed on a base substrate of the touch panel. In this context, for convenience of description, a layer where the patterned touch electrodes are located is referred to as a “touch layer” or “touch pattern layer”. As another example, the plurality of touch electrodes may include a plurality of patterned driving electrodes and a plurality of patterned sensing electrodes. In one example, the plurality of patterned driving electrodes and the plurality of patterned sensing electrodes may be located on the same layer. In such a case, a layer where the plurality of patterned driving electrodes and the plurality of patterned sensing electrodes are located may be referred to as the “touch layer ” or “touch pattern layer”. In another example, the plurality of patterned driving electrodes and the plurality of patterned sensing electrodes may be located in different layers. In such a case, one of a layer where the plurality of patterned driving electrodes and a layer where the plurality of patterned sensing electrodes are located may be referred to as a first touch pattern layer, and the other one may be referred to as a second touch pattern layer.

As mentioned above, in the existing OGS touch panel, the touch layer is directly formed on the glass carrier. Therefore, once the glass carrier is cracked, the electrodes in the touch layer will be broken, resulting in a failure of the touch function. Since the glass carrier is usually the outermost substrate of the touch panel, a risk that the glass carrier is cracked is high. As a result, it may bring great inconvenience to users. To this end, the inventor of the present application provides a touch panel with an improved structure, in which the touch layer may be still effectively operated when the outermost substrate of the touch panel is cracked.

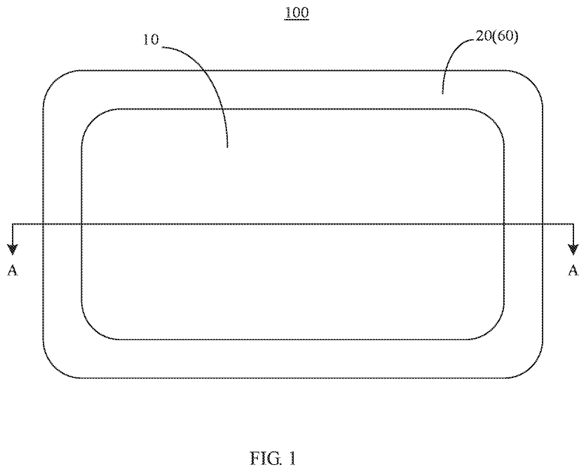

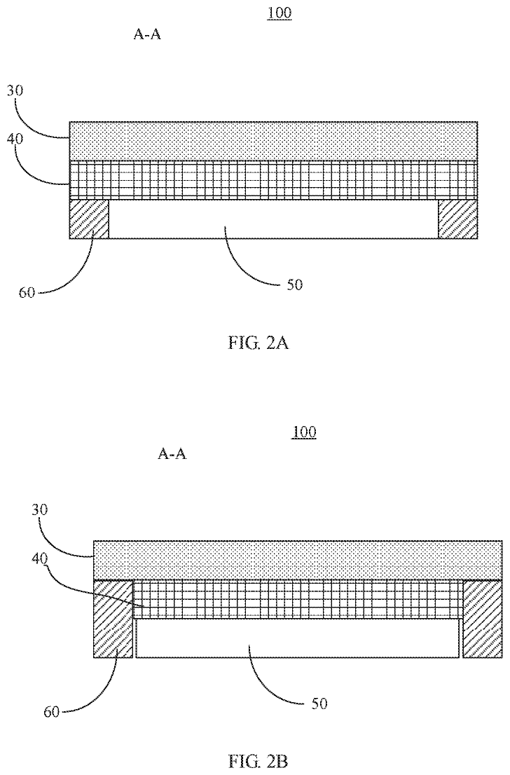

FIG. 1 and FIG. 2A illustrate a touch panel 100 according to some embodiments of the present disclosure. FIG. 1 is a plan view of the touch panel 100. FIG. 2A is a sectional-view taken along line A-A in FIG. 1. As can be seen from FIG. 1, the touch panel 100 includes a display area 10 and a non-display area 20. The display area 10 functions to display an image, and the non-display area 20 is located on a periphery of the display area 10. For example, the non-display area 20 may be used for routing lead wires of touch electrodes. As shown in FIG. 2A, the touch panel 100 may include a base substrate 30, a touch layer 50 disposed on the base substrate 30, and a transparent flexible insulating layer 40 located between the touch layer 50 and the base substrate 30. The touch layer 50 may include, for example, various touch electrode patterns, so as to implement touch operations. As can be seen from FIG. 2A, in the touch panel 100 according to the embodiments of the present disclosure, the touch layer 50 is not directly formed on the base substrate 30, but the transparent flexible insulating layer 40 is provided between the touch layer 50 and the base substrate 30. In this way, when the base substrate 30 is cracked, the flexible insulating layer 40 may still be attached onto the base substrate without being cracked. In such a case, the flexible insulating layer 40 may still support the touch layer 50. Thus, the touch layer 50 may be still effectively operated when the base substrate 30 is cracked.

In the embodiments of the present disclosure, for example, the flexible insulating layer 40 may be made of an organic material or an inorganic material, such as transparent polyimide (PI) or a protective layer (OC) material. The flexible insulating layer 40 is bendable and flexible so that it may be still attached onto glass fragments when the glass substrate is cracked, so as not to be broken. As an example, a thickness of the flexible insulating layer 40 may be between 1 micrometer (μm) and 10 micrometers. As an example, the flexible insulating layer 40 may be in contact with a surface of the base substrate 30 facing the touch layer 50, thereby helping the flexible insulating layer 40 to attach onto the fragments of the base substrate 30 when the base substrate 30 is cracked.

For the sake of brevity, in FIG. 2A, the touch layer 50 is shown with only one layer. However, those skilled in the art should understand that the number of the touch layer 50 may be more than one. Structures of the touch layer used in existing touch panels in the related art may all be employed. As an example, the flexible insulating layer 40 may be in contact with a surface (upper surface of the touch layer 50 in FIG. 2A) of the touch layer 50 that is closest to the base substrate 30, thereby facilitating that the flexible insulating layer 40 supports the touch layer 50.

As an example, an orthographic projection of the flexible insulating layer 40 on the base substrate 30 may completely cover an orthographic projection of the touch layer 50 on the base substrate 30. That is, the flexible insulating layer 40 may completely cover the entire touch layer 50. In this way, it helps the flexible insulating layer 40 to provide a complete protection for all parts of the touch layer 50.

A peripheral shielding layer 60 is also shown in FIG. 2A. The peripheral shielding layer 60 is disposed in the non-display area 20, and mainly functions to shield components located in the non-display area 20, such as touch lead wires, screws and the like, thereby avoiding affecting a display effect. As an example, the peripheral shielding layer 60 may be disposed on the base substrate 30 or on the flexible insulating layer 40. The peripheral shielding layer 60 may be opaque to perform the shielding function better. As an example, the peripheral shielding layer 60 may be made of a black photoresist material, a white photoresist material, or a colored photoresist material, and may be correspondingly referred to as a black frame, a white frame, or a colored frame. In the embodiments shown in FIG. 1, the peripheral shielding layer 60 is provided in the entire non- display area 20 to more clearly distinguish the non-display area 20 from the display area 10.

In the embodiments of the present disclosure, the flexible insulating layer 40 may completely cover the entire display area 10 and the non-display area 20. As shown in FIG. 1 and FIG. 2A, the orthographic projection of the flexible insulating layer 40 on the base substrate 30 may cover the display area 10, and also at least partially overlaps with the non-display area 20. Optionally, the flexible insulating layer 40 may be located only in the display area 10 of the touch panel. With reference to FIG. 1 and FIG. 2B, the orthographic projection of the flexible insulating layer 40 on the substrate 30 coincides with the display area 10.

For example, an orthographic projection of the peripheral shielding layer 60 on the base substrate 30 may coincide with the non-display area 20.

For example, as shown in FIG. 2A and FIG. 2B, the orthographic projection of the peripheral shielding layer 60 on the base substrate 30 does not overlap with the orthographic projection of the touch layer 50 on the base substrate 30.

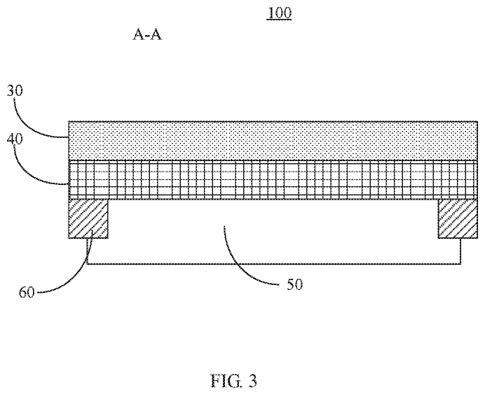

For example, in order to avoid an influence on a forming process of the touch layer 50 by the flexible insulating layer 40 and to facilitate the formation of the touch layer 50, the peripheral shielding layer 60 may be formed between the flexible insulating layer 40 and the touch layer 50. That is, the orthographic projection of the peripheral shielding layer 60 on the base substrate 30 may overlap with the orthographic projection of the touch layer 50 on the base substrate 30. As shown in FIG. 3, both sides of the touch layer 50 may cover at least a part of the peripheral shielding layer 60. In this way, in a manufacturing process of the touch panel, the flexible insulating layer 40 may be formed firstly, and then the peripheral shielding layer 60 and the touch layer 50 may be formed, so that it is beneficial to forming a planar flexible insulating layer 40 and may also prevent the flexible insulating layer 40 from affecting an existing process. In addition, such a structure also facilitates leading out the electrodes in the touch layer 50 and facilitates an electrical connection between the touch electrodes and the lead wires.

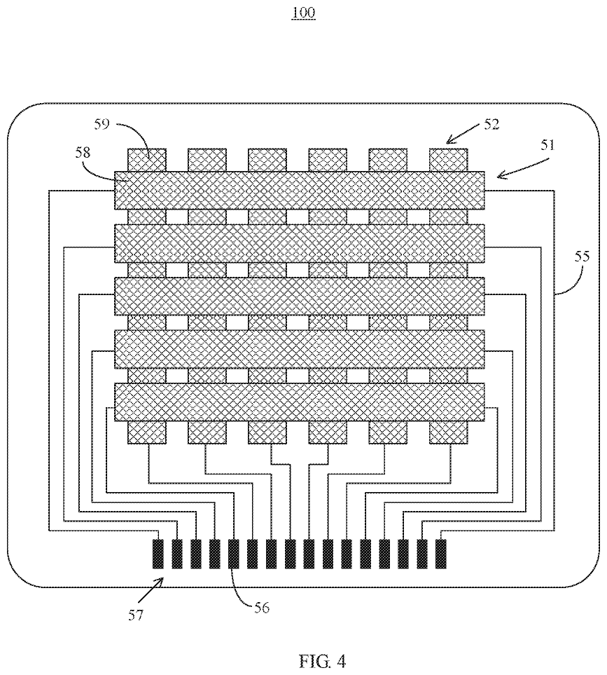

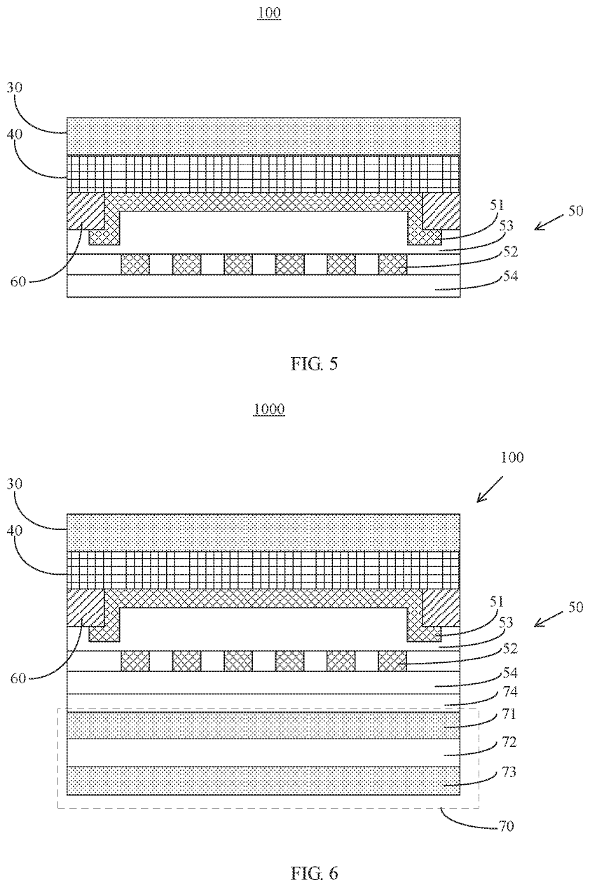

FIG. 4 and FIG. 5 illustrate exemplary structures of a touch layer in a touch panel according to some embodiments of the present disclosure. For example, the embodiments shown in FIG. 4 and FIG. 5 specifically shows examples of the touch layer 50 shown in FIG. 3. As can be seen in FIG. 5, the touch layer 50 includes a first touch pattern layer 51 and a second touch pattern layer 52. The first touch pattern layer 51 is closer to the flexible insulating layer 40 than the second touch pattern layer 52. The touch panel 100 may further include a first insulating layer 53 and a second insulating layer 54. The first insulating layer 53 is located between the first touch pattern layer 51 and the second touch pattern layer 52. The second insulating layer 54 is located on a side of the second touch pattern layer 52 facing away from the flexible insulating layer 40. As an example, the first touch pattern layer 51 may be disposed adjacent to the flexible insulating layer 40 to contact the flexible insulating layer 40. The structure of the touch layer 50 in the touch panel according to the embodiments of the present disclosure is not limited thereto. According to design requirements of the touch layer, the touch layer 50 may include a single touch pattern layer or more than two touch pattern layers.

As an example, the first insulating layer 53 and the second insulating layer 54 may be transparent organic layers (such as a transparent protective layer (OC), a polyimide (PI) layer, or the like) or transparent inorganic layers (such as inorganic silicon oxide materials, silicon oxynitride layers, or the like). However, in the embodiments of the present disclosure, the first insulating layer 53 and the second insulating layer 54 are not limited thereto.

The first touch pattern layer 51 and the second touch pattern layer 52 may have various electrode patterns. For example, a plurality of first strip electrodes 58 extending in a first direction (horizontal direction in FIG. 4) are provided in the first touch pattern layer 51, and a plurality of second strip electrodes 59 extending in a second direction (vertical direction in FIG. 4) are provided in the second touch pattern layer 52. The strip electrodes in the first touch pattern layer 51 and the strip electrodes in the second touch pattern layer 52 may be used as driving electrodes and sensing electrodes in a mutual capacitance touch sensor, respectively. As an example, each of the strip electrodes described above may be formed of metal mesh. The first touch pattern layer 51 and the second touch pattern layer 52 each may be formed of a metal layer, or may be formed of a non-metal layer (for example, a non-metal material such as indium tin oxide (ITO), carbon nanotubes, etc.). The touch layer 50 may have a single-layer structure, for example, for a touch panel using a self-capacitive touch sensor, or it may have a double-layer structure as described above, or it may have a structure with more layers. Compared with the single-layer structure of the self-capacitive touch sensor, the double-layer structure of the mutual-capacitive touch sensor has better sensing accuracy.

Lead wires 55 of the electrodes in the touch pattern layer are further shown in FIG. 4. The lead wires 55 may serve to electrically connect the electrodes to an integrated circuit or a power source, for example, they may be connected to pins 56 in an interface 57 located at the periphery of the touch panel, and the pins 56 may be connected to an external circuit. As an example, the lead wires 55 which are connected to respective electrodes in both the first touch pattern layer 51 and the second touch pattern layer 52 may be disposed in the same layer. For example, the lead wires 55 may be located in the same layer as the first touch pattern layer 51 or the second touch pattern layer 52, and via holes are provided in a first insulating layer 53 located between the first touch pattern layer 51 and the second touch pattern layer 52 to electrically connect the lead wires 55 with the electrodes which are located in a different layer from the lead wires 55. In the embodiments of the present disclosure, the lead wires 55 and the pins 56 may be disposed in the non-display area 20, and for example, may be shielded by the peripheral shielding layer 60. The first stripe electrodes 58 in the first touch pattern layer 51 and the second stripe electrodes 59 in the second touch pattern layer 52 may be disposed in the display area 10 or in the non-display area 20 as required.

In the embodiments of the present disclosure, the structure of the touch layer 50 is not limited to the above-mentioned form, and any structure of the touch layer which is known in the art and applicable to the touch panel may be adopted.

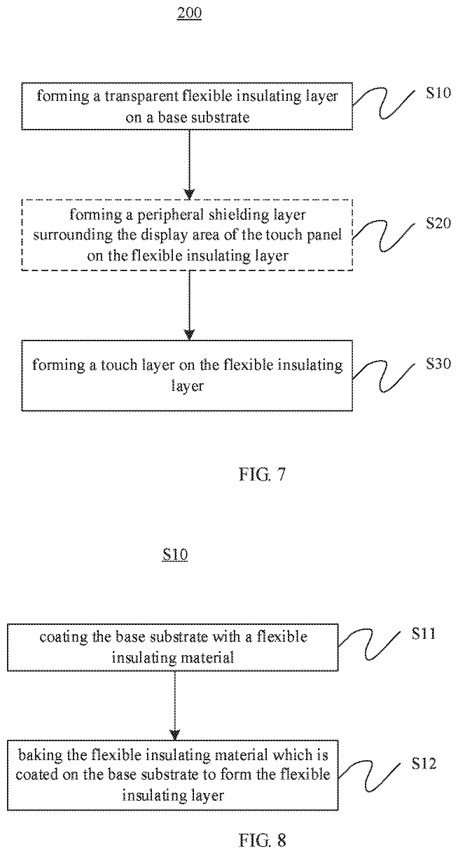

Some embodiments of the present disclosure also provide a touch display device 1000. As shown in FIG. 6, the touch display device 1000 includes a touch panel 100. In addition to the touch structures such as the base substrate 30, the touch layer 50 and the transparent flexible insulating layer 40 as described above, the touch display device 1000 includes a display component 70. The display component 70 is located on a side of the touch layer 50 facing away from the base substrate 30 (in FIG. 6, the display component 70 is located below the touch layer 50). In FIG. 6, the display component 70 is shown in the form of a liquid crystal display component. For example, the display component 70 may include structures such as a color filter substrate 71, an array substrate 73, and a liquid crystal layer 72 located between the color filter substrate 71 and the array substrate 73. Of course, in the embodiments of the present disclosure, the structure of the display component 70 is not limited thereto, and for example, it may also be an organic light emitting diode (OLED) display component, a quantum dot light emitting display component, or the like. For example, an adhesive layer 74 (such as OCA or the like) may be provided between the display component 70 and the touch layer 50. In the example shown in FIG. 6, the touch structure located above the display component 70 includes only one substrate (i.e., the base substrate 30), and the touch panel having such a structure may be typically referred to as an OGS touch panel. In other words, the base substrate 30 also serves as a protective cover of the touch panel. It should be understood that the protective cover of the touch panel is a cover where the touch panel faces the user, and components such as the touch layer and the display component are located on a side of the protective cover facing away from the user and are protected by the protective cover. For example, the base substrate 30 is a glass substrate for protecting various components provided on the touch panel.

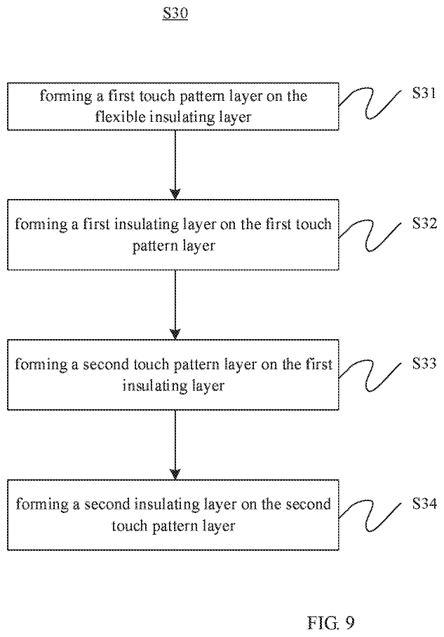

Some embodiments of the present disclosure also provide a manufacturing method 200 of a touch panel. As shown in FIG. 7, the manufacturing method may include the following steps:

step S10: forming a transparent flexible insulating layer on a base substrate; and

step S30: forming a touch layer on the flexible insulating layer.

By means of the manufacturing method, the transparent flexible insulating layer 40 may be formed on the base substrate 30 before the touch layer 50 is formed on the base substrate 30. As described above, when the base substrate 30 is cracked, the flexible insulating layer 40 may protect the touch layer 50 from being damaged.

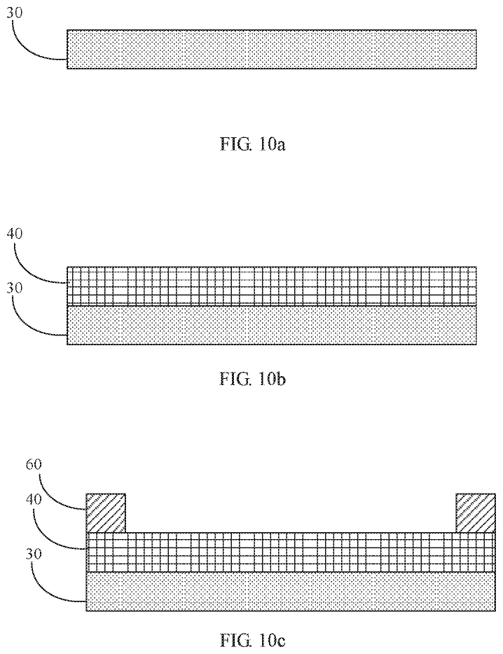

For the step S10, as an example, as shown in FIG. 8, the step S10 may further include:

step S11: coating the base substrate with a flexible insulating material; and

step S12: baking the flexible insulating material which is coated on the base substrate to form the flexible insulating layer.

In an example, if it is desired that the flexible insulating layer 40 covers the entire surface of the base substrate 30 incompletely (for example, covers only a part of the non-display area), processes such as photolithography (exposure), development and the like may be performed after the above step S12 to pattern the flexible insulating layer 40. If it is desired that the flexible insulating layer 40 completely covers the entire surface of the base substrate 30, the patterning process may not be performed.

As an example, as shown in FIG. 7, the manufacturing method 200 may further include:

step S20 (shown as a dashed box in FIG. 7): forming a peripheral shielding layer surrounding the display area of the touch panel on the flexible insulating layer.

As described above, the peripheral shielding layer 60 may be used to shield components located in the non-display area of the touch panel. Specifically, the flexible insulating layer 40 may be coated with a black, white, or colored photoresist material, and then the black, white, or colored photoresist material may be patterned through processes such as photolithography (exposure), development and the like, so that the peripheral shielding layer 60 with black frame, white frame or colored frame may be formed. A position of the peripheral shielding layer may correspond to the non-display area of the touch panel. It should be noted that, theoretically, the peripheral shielding layer 60 may be formed on the base substrate 30 before the flexible insulating layer 40 is formed.

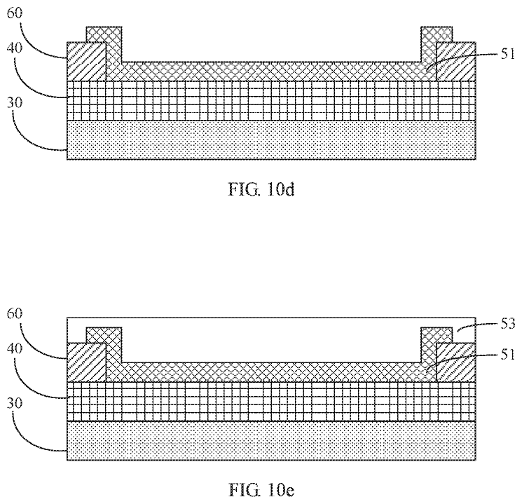

Taking the case where the touch layer 50 includes the first touch pattern layer 51 and the second touch pattern layer 52 as an example, as shown in FIG. 9, the above step S30 may include:

step S31: forming a first touch pattern layer on the flexible insulating layer;

step S32: forming a first insulating layer on the first touch pattern layer;

step S33: forming a second touch pattern layer on the first insulating layer; and

step S34: forming a second insulating layer on the second touch pattern layer.

In the step S31, for example, a first metal layer may be formed on the flexible insulating layer 40 by magnetron sputtering, and the first metal layer may be patterned by a process including photoresist coating, exposure, development and etching, to form the first touch pattern layer 51.

In the step S32, for example, a first insulating layer 53 may be formed on the first touch pattern layer 51 by a vapor deposition or coating process, and the first insulating layer 53 may be patterned by a process (also referred to as a yellow-light photolithography process) including photoresist coating, exposure, and development.

In the step S33, similar to the above step S31, for example, a second metal layer may be formed on the first insulating layer 53 by magnetron sputtering, and the second metal layer may be patterned by a process including photoresist coating, exposure, development and etching, to form the second touch pattern layer 52.

In the step S34, similar to the above step S32, for example, a second insulating layer 54 may be formed on the second touch pattern layer 52 by a vapor deposition or coating process, and the second insulating layer 54 may be patterned by a process including photoresist coating, exposure, and development. The second insulating layer 54 may be used as a protective layer.

It should be noted that, in the above step S31 and step S33, the first touch pattern layer 51 and the second touch pattern layer 52 may be formed not only by patterning a metal layer, but also by patterning a non-metal conductive layer (e.g., ITO layer).

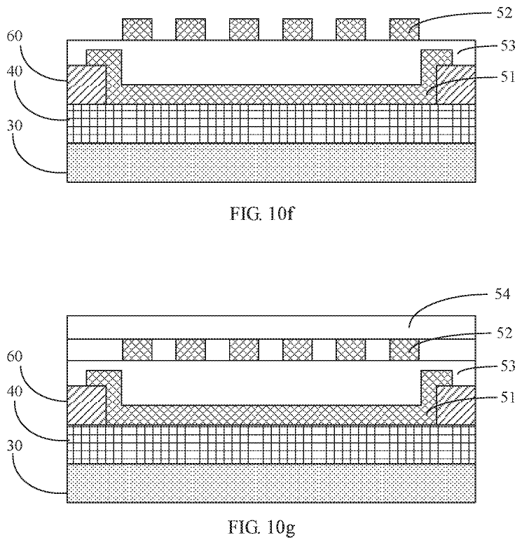

FIG. 10a to FIG. 10g illustrate an exemplary complete manufacturing process of a touch panel. The base substrate 30, the flexible insulating layer 40, the peripheral shielding layer 60, the first touch pattern layer 51, the first insulating layer 53, the second touch pattern layer 52, and the second insulating layer 54 may be formed in sequence according to the above steps.

Those skilled in the art should understand that the manufacturing method of the touch panel may further include steps for forming lead wires and circuits which are related to the touch operations and steps for forming the display component 70. In the present disclosure, these steps may adopt the same scheme as that in the related art, and are not repeated here.

As an example, in an actual process, the base substrate 30 may be manufactured independently, or may be formed by cutting a large substrate (such as glass plate) into small pieces. Such a cutting process may be performed after the above-mentioned various film layer structures have been formed on the large substrate.

The technical concept of the present disclosure has been introduced by taking the OGS touch panel as an example in the above description. However, the embodiments of the present disclosure are not limited to the OGS touch panel, and may also be applied to some GG touch panels or GF touch panels.

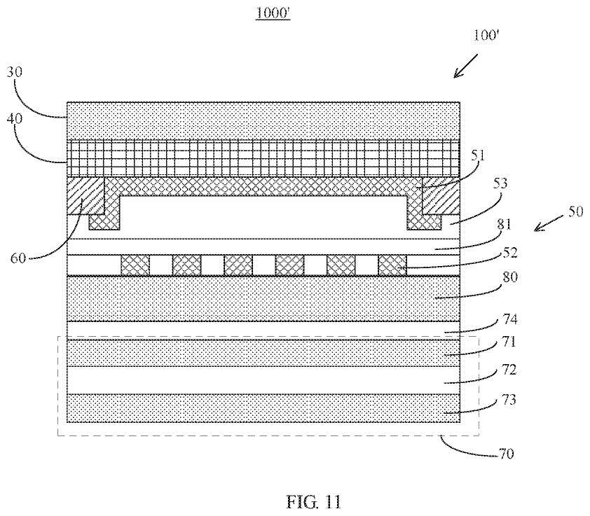

FIG. 11 shows an example in which the technical concept of the present disclosure is applied to a GG touch panel. FIG. 11 illustrates a touch display device 1000′ according to some embodiments of the present disclosure. The touch display device 1000′ includes a touch panel 100′. In this example, two touch layers, namely a first touch pattern layer 51 and a second touch pattern layer 52, are shown. Different from the embodiments shown in FIG. 6, the exemplary touch panel 100′ shown in FIG. 11 includes not only the base substrate 30 located at the outermost side of the touch panel, but also an additional substrate 80 (e.g., made of glass), that is, the touch structure adopts a dual substrate structure. The first touch pattern layer 51 is disposed on the base substrate 30, and the second touch pattern layer 52 is formed on the additional substrate 80, and then the base substrate 30 carrying the first touch pattern layer 51 is attached to the additional substrates 80 carrying the second touch pattern layer 52. In this example, a flexible insulating layer 40 is provided between the base substrate 30 and the first touch pattern layer 51. Specifically, in the embodiment shown in FIG. 11, the touch panel 100′ includes the base substrate 30 and the additional substrate 80, the first touch pattern layer 51 and the second touch pattern layer 52 which are located between the base substrate 30 and the additional substrate 80, a first adhesive layer 81 between the first touch pattern layer 51 and the second touch pattern layer 52, and the flexible insulating layer 40 between the first touch pattern layer 51 and the base substrate 30. Optionally, a first insulating layer 53 (for example, used for planarization) may be further provided between the first adhesive layer 81 and the first touch pattern layer 51, but the first insulating layer 53 is not necessary. The first touch pattern layer 51 is closer to the base substrate 30 than the second touch pattern layer 52. The second touch pattern layer 52 is closer to the additional substrate 80 than the first touch pattern layer 51. In the exemplary touch display device 1000′ shown in FIG. 11, the touch panel 100′ may further be provided with a display component 70 (such as liquid crystal display component, OLED display component, and quantum dot display component, or the like). The display component 70 is located on a side of the additional substrate 80 facing away from the base substrate 30 (or on a side of the touch panel 100′ facing away from the base substrate 30). In the example of the touch panel 100′ based on the GG touch technology shown in FIG. 11, the flexible insulating layer 40 may also serve to avoid the touch layer 50 (the first touch pattern layer 51) from being broken when the base substrate 30 is cracked.

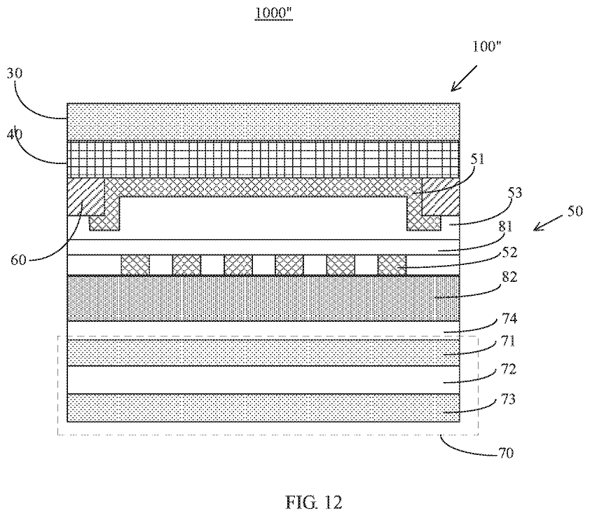

FIG. 12 shows another example in which the technical concept of the present disclosure is applied to a GF touch panel. FIG. 12 illustrates a touch display device 1000″ according to some embodiments of the present disclosure. The touch display device 1000″ includes a touch panel 100″. In this example, two touch layers, namely a first touch pattern layer 51 and a second touch pattern layer 52, are shown. The touch display device 1000″ is similar to the touch display device 1000′ shown in FIG. Different from the embodiments shown in FIG. 11, the additional substrate 80 in FIG. 11 is replaced with a supporting film 82 (for example, made of polyethylene terephthalate (abbreviated as PET)) in FIG. 12. The first touch pattern layer 51 is disposed on the base substrate 30, and the second touch pattern layer 52 is formed on the supporting film 82, and then the base substrate 30 carrying the first touch pattern layer 51 is attached to the supporting film 82 carrying the second touch pattern layer 52. In this example, a flexible insulating layer 40 is provided between the base substrate 30 and the first touch pattern layer 51. Specifically, in the embodiments shown in FIG. 12, the touch panel 100″ includes the base substrate 30, the supporting film 82, the first touch pattern layer 51 and the second touch pattern layer 52 which are located between the base substrate 30 and the supporting film 82, a first adhesive layer 81 between the first touch pattern layer 51 and the second touch pattern layer 52, and the flexible insulating layer 40 between the first touch pattern layer 51 and the base substrate 30. Similar to the previous embodiments, optionally, a first insulating layer 53 may be provided between the first adhesive layer 81 and the first touch pattern layer 51, but the first insulating layer 53 is not necessary. The first touch pattern layer 51 is closer to the base substrate 30 than the second touch pattern layer 52. The second touch pattern layer 52 is closer to the supporting film 82 than the first touch pattern layer 51. In the exemplary touch display device 1000″ shown in FIG. 12, the touch panel 100″ may further be provided with a display component 70 (such as liquid crystal display component, OLED display component, and quantum dot display component, etc.). The display component 70 is located on a side of the supporting film 82 facing away from the base substrate 30 (or on a side of the touch panel 100″ facing away from the base substrate 30). In the example of the touch panel 100″ based on the GF touch technology shown in FIG. 12, the flexible insulating layer 40 may also serve to avoid the touch layer 50 (the first touch pattern layer 51) from being broken when the base substrate 30 is cracked.

As an example, the orthographic projection of the flexible insulating layer 40 on the base substrate 30 may completely cover an orthographic projection of each of the first touch pattern layer 51 and the second touch pattern layer 52 on the base substrate 30, that is, the orthographic projection of each of the first touch pattern layer 51 and the second touch pattern layer 52 on the base substrate 30 falls into the orthographic projection of the flexible insulating layer 40 on the base substrate 30. That is, the flexible insulating layer 40 may completely cover all the touch electrodes, thereby helping the flexible insulating layer 40 to provide complete protection for all touch electrodes.

As an example, in the examples of the touch panels shown in FIG. 11 and FIG. 12, a peripheral shielding layer 60 may also be provided. For example, the peripheral shielding layer 60 may be located between the base substrate 30 and the first touch pattern layer 51. As an example, in the examples of the touch display devices shown in FIG. 11 and FIG. 12, the display component 70 may be bonded to the additional substrate 80 or the supporting film 82 by an adhesive layer 74 located between the display component 70 and the additional substrate 80 or the supporting film 82.

Those skilled in the art should understand that some known film structures such as cathode, anode and the like need to be provided on the display component to achieve necessary functions. These film structures may be selected and designed as required, and may be manufactured by manufacturing processes which are known in the related art. Since only known technologies in the related art are involved, detailed descriptions of these film structures and manufacturing processes are not repeated here.

Although the present disclosure has been described with reference to the accompanying drawings, the embodiments disclosed in the drawings are intended to exemplify the embodiments of the present disclosure, and should not be construed as limiting the present disclosure. Sizes and scales in the drawings are only schematic and should not be construed as limiting the present disclosure.

The above embodiments only exemplarily illustrate the principle and configuration of the present disclosure and are not intended to limit the present disclosure. Those skilled in the art should understand that any changes and improvements which may be made without departing from the general concept of the present disclosure will fall within the scope of the present disclosure. The protection scope of the present disclosure shall be defined by claims of this application.

1. A touch panel, comprising:
a base substrate;
a touch layer on the base substrate; and
a transparent flexible insulating layer between the touch layer and the base substrate.

2. The touch panel according to claim 1, wherein the flexible insulating layer is in contact with a surface of the base substrate facing the touch layer.

3. The touch panel according to claim 1, wherein an orthographic projection of the flexible insulating layer on the base substrate completely covers an orthographic projection of the touch layer on the base substrate.

4. The touch panel according claim 1, wherein the touch layer comprises:
a first touch pattern layer; and
a second touch pattern layer, the first touch pattern layer being closer to the flexible insulating layer than the second touch pattern layer; and
wherein the touch panel further comprises:
a first insulating layer between the first touch pattern layer and the second touch pattern layer; and
a second insulating layer located on a side of the second touch pattern layer facing away from the flexible insulating layer.

5. The touch panel according to claim 1, wherein the flexible insulating layer is made of polyimide.

6. The touch panel according to claim 1, wherein the flexible insulating layer has a thickness in a range of 1 μm to 10 μm.

7. The touch panel according claim 1, wherein the base substrate serves as a protective cover of the touch panel.

8. The touch panel according to claim 7, wherein the base substrate is a glass substrate.

9. The touch panel according claim 1, wherein the touch panel comprises a display area and a non-display area on a periphery of the display area, and the touch panel further comprises a peripheral shielding layer located in the non-display area and between the flexible insulating layer and the touch layer.

10. The touch panel according to claim 9, wherein an orthographic projection of the flexible insulating layer on the base substrate coincides with the display area.

11. The touch panel according to claim 9, wherein an orthographic projection of the flexible insulating layer on the base substrate covers the display area, and at least partially overlaps with the non-display area.

12. The touch panel according claim 1, wherein the touch layer comprises a first touch pattern layer; and
wherein the touch panel further comprises:
an additional substrate on a side of the touch layer facing away from the base substrate;
a second touch pattern layer, which is located on a side of the additional substrate facing the base substrate and is closer to the additional substrate than the first touch pattern layer; and
an adhesive layer between the first touch pattern layer and the second touch pattern layer.

13. The touch panel according claim 1, wherein the touch layer comprises a first touch pattern layer; and
wherein the touch panel further comprises:
a supporting film on a side of the touch layer facing away from the base substrate;
a second touch pattern layer, which is located on a side of the supporting film facing the base substrate and is closer to the supporting film than the first touch pattern layer; and
an adhesive layer between the first touch pattern layer and the second touch pattern layer.

14. The touch panel according to claim 12, wherein an orthographic projection of each of the first touch pattern layer and the second touch pattern layer on the base substrate falls into an orthographic projection of the flexible insulating layer on the base substrate.

15. A touch display device, comprising:
the touch panel according to claim 1.

16. A manufacturing method of a touch panel, comprising:
forming a transparent flexible insulating layer on a base substrate; and
forming a touch layer on the flexible insulating layer.

17. The manufacturing method according to claim 16, wherein the step of forming a transparent flexible insulating layer on a base substrate comprises:
coating the base substrate with a flexible insulating material; and
baking the flexible insulating material coated on the base substrate to form the flexible insulating layer.

18. The manufacturing method according to claim 16, wherein, before forming the touch layer, the method further comprises:
forming a peripheral shielding layer surrounding a display area of the touch panel on the flexible insulating layer.

19. The touch panel according to claim 13, wherein an orthographic projection of each of the first touch pattern layer and the second touch pattern layer on the base substrate falls into an orthographic projection of the flexible insulating layer on the base substrate.

20. The touch panel according to claim 1, wherein the touch panel is a One Glass Solution (OGS) touch panel.
